(19) United States
(12) Patent Application Publication
(10) Pub. No.: US 2002/0071350 A1
(43) Pub. Date: Jun. 13, 2002

(54) Intelligent data storage device

(76) Inventor: Robert Barry Wood, Niwot, CO (US)

Correspondence Address: MERCHANT & GOULD PC, P.O. BOX 2903, MINNEAPOLIS, MN, 55402-0903, US

(21) Appl. No.: 09/938,144

(22) Filed: Aug. 23, 2001

Related U.S. Application Data
(60) Provisional application No. 60/227,622, filed on Aug. 23, 2000.

(51) Int. Cl. G11B 21/10; G11B 7/00; G11B 21/12; G11B 21/08; G11B 19/00

(52) U.S. Cl. 369/24.01; 369/43

(57) ABSTRACT

A data storage device includes a microprocessor running a general-purpose operating system including an application program. Included is memory storing the operating system and application program. The data storage device includes mass storage, is connected to a communication network, and an input/output module communicates with a node connected to the communication network. The data storage device is assembled in a form factor assembly not greater than three and one half (3 ½ ) inches.

### RELATED APPLICATIONS

This application claims priority of United States provisional application Serial No. 60/227,622, filed Aug. 23, 2000.

### FIELD OF THE INVENTION

This application relates generally to disc drives and more particularly to an intelligent storage element.

### BACKGROUND OF THE INVENTION

In the field of data storage, self-contained, integrated, adaptable data storage units are not available. Typical hard disc drives are not adaptable because they do not allow for application customization. Application data storage technology does not allow for easy portability with consistent presentation. Prior approaches provide an interface for a computer to communicate with the data storage unit wherein the computer is separate from the storage unit and the storage unit itself has no functionality beyond storing what it is directed to store. Inefficiencies exist because of layers of abstraction in the interface. For example, the application data stored on the data storage device is removed from the processing and presentation of that data, which is typically carried out by the connected computer.

Traditional approaches to computer technology have discouraged portability of application data because the application that processes the data is not coupled to the application data. Typically, an application running on the computer is user or computer platform dependent. As a result, data on the disc drive may be presented differently from computer to computer. For example, a user may develop application data on one computer only to have the data be presented differently on another computer because the application software is set up differently on the other computer. Consequently, the application data is not personalized. The problem of portability is also demonstrated by the typical difficulty faced by users while installing a hard disc drive. Typically, when a hard disc drive is installed in a computer, significant effort must be expended in configuring the disc drive to work properly with the computer. Installing a hard disc drive typically involves rebooting the computer and can involve reconfiguring the computer system disc drive interface to recognize the hard disc drive. This problem arises because the disc drive has very minimal processing power. The processing power is in the computer and the computer must be configured to work with the disc drive.

Another problem with prior approaches to mass data storage exists as a result of the lack of coupling between application data and the application using the data. Inefficiencies result from multiple layers of abstraction required to read data from and write data to a hard disc drive. In prior approaches, an application running on a computer interacts with a file system to retrieve data from a data disc. The file system maps a logical block address to a physical block address. Subsequently, the physical block address is mapped to a cylinder head sector. Often, a redirection is required to direct the data storage device to another data storage device. Furthermore, drivers and interfaces employed by computer manufacturers to access data from the data storage device are typically generalized to work with a variety of different bus structures and storage devices. As a result, the interaction between a computer and a particular hard disc drive is suboptimal, not taking advantage of the technical features of the specific hard disc drive. Mappings, redirection, and generalized drivers are abstractions that result in suboptimal retrieval of data from the storage device.

Further, prior data storage systems, without additional hardware, cannot be adapted to user-specific applications. Typical hard disc drives are not customizable. For example, a typical hard disc drive cannot be programmed to behave as a web server. Applications that use a typical data storage device must provide an additional interface to use the data storage device in a specialized or dedicated application. Additionally, data storage device manufacturers have not been able to take advantage of the trend toward miniaturization that has occurred in the computer industry while simultaneously increasing the functionality of the data storage devices.

Accordingly there is a need for an intelligent storage element that provides improved portability, adaptability, and personalized application data.

### SUMMARY OF THE INVENTION

Against this backdrop various embodiments of the present invention have been developed. Various embodiments of the present invention relate to tightly coupling application data stored on a hard disc drive with the application that processes and presents the application data. By tightly coupling the data with the application, a hard disc drive can be viewed as an intelligent storage element, serving a customized purpose. The intelligent storage element enables improved portability of personalized application data. More than one intelligent storage element working together can enable distributed processing.

A disc drive includes a microprocessor running a general-purpose operating system including an application program. Included is memory storing the operating system and application program. The disc drive is connected to a communication network and an input/output module communicates with a node connected to the communication network.

These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive incorporating an embodiment of the present invention showing the primary internal components.

FIG. 2 is a functional block diagram of the disc drive of FIG. 1.

FIG. 3 is a functional block diagram of the intelligent storage element of FIG. 1.

FIG. 4 illustrates a suitable computing environment for the disc drive of FIG. 1.

FIG. 5 illustrates a distributed processing system implementing the disc drive shown in FIG. 1.

FIG. 6 is a flow control diagram illustrating exemplary method steps involved in a distributed processing system such as the system shown in FIG. 5.

### DETAILED DESCRIPTION

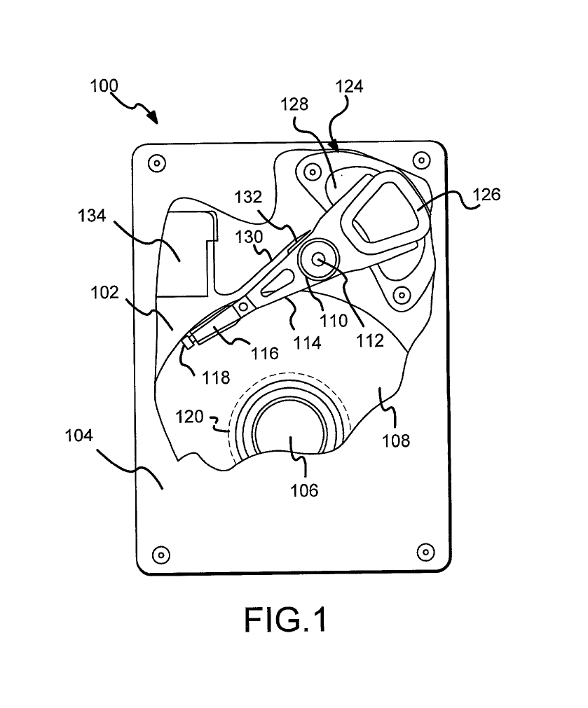

A disc drive 100 constructed in accordance with a preferred embodiment of the present invention is shown in FIG. 1. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106 which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118 which includes an air bearing slider enabling the head 118 to fly in close proximity above the corresponding surface of the associated disc 108.

During a seek operation, the track position of the heads 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well-known Lorentz relationship. As the coil 126 moves, the actuator assembly 110 pivots about the bearing shaft assembly 112, and the heads 118 are caused to move across the surfaces of the discs 108.

The spindle motor 106 is typically de-energized when the disc drive 100 is not in use for extended periods of time. The heads 118 are moved over park zones 120 near the inner diameter of the discs 108 when the drive motor is de-energized. The heads 118 are secured over the park zones 120 through the use of an actuator latch arrangement, which prevents inadvertent rotation of the actuator assembly 110 when the heads are parked.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base deck 102 to a disc drive printed circuit board (not shown) mounted to the bottom side of the disc drive 100.

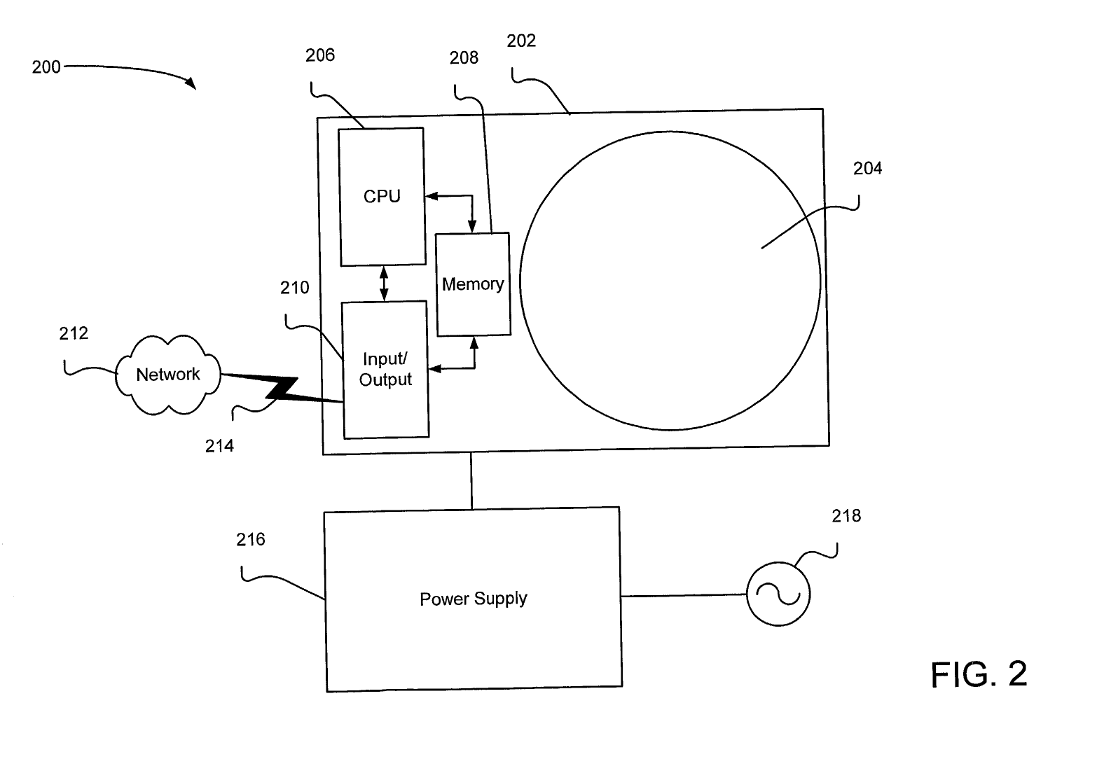

FIG. 2 illustrates an exemplary environment 200 utilizing an embodiment of the present invention. An intelligent storage element 202 couples application software that uses application data with application data that is stored on a data storage disc 204. A central processing unit (CPU) 206 in the intelligent storage element (ISE) 202 runs a general-purpose operating system (OS). The OS is operable to execute application programs as processes or threads in a larger process. The CPU 206 can be any microprocessor known in the art. Examples include Intel, Motorola, or the MachZ line of microprocessors. Operating system software is preferably stored on the data storage disc 204 and loaded into a memory medium 208 when the ISE 202 powers up. A Basic Input/Output System (BIOS) may include boot code, which may reside on a combination of the memory medium 208 and the data storage disc 204. The memory medium 208 may include, but is not limited to, random access memory (RAM), read only memory (ROM), flash memory, or electrically erasable programmable ROM (EEPROM). The CPU 206 is operably connected to the memory medium 208 and may include local memory, whereby the CPU 206 can load the OS into a local memory and execute the OS on power up.

The CPU 206 is also operably connected to an input/output module 210 providing an interface to an external network 212. The input/output module 210 preferably employs receivers, transmitters, and data buffers to receive, send, and store data. The input/output module 210 is connected to a communications link 214 via which the input/output module 210 communicates with nodes communicating on the network 212. A node can be any computerized device, including, but not limited to, a computer, a cellular telephone, a personal digital assistant, or another intelligent storage element. The communications link 214 can be any communications connection including, but not limited to, a direct wired connection, a packet protocol wired network, or a wireless network. Connected to the ISE 202 is a power supply 216 supplying power to the ISE 202. The power supply 216 is preferably a small form factor power adapter converting alternating current power from a power source 218 into direct current power compatible with the ISE 202.

One embodiment of the ISE 202 includes the Linux operating system (OS) and communicates over a local area network (LAN) 212 via an Ethernet connection 214. Nodes communicating on the LAN send and receive data to and from the ISE 202. The input/output module 210 may support any communication protocol, including, but not limited to, the hypertext transport protocol (HTTP). Thus, the ISE 202 may have one or more uniform resource locators (URLs) associated with the ISE 202. The input/output module 210 transmits and receives hypertext markup language (HTML) data to and from nodes connected to the LAN. One application running on the ISE 202 may be a network file system (NFS), which allows data stored on the data storage disc 204 to be shared with nodes across the LAN. Using a NFS, the data stored on the ISE 202 will appear on a remote node as if the data were local to the node. Those skilled in the art will recognize many alternative embodiments of the input/output module 210 in accordance with the present invention.

The ISE 202 is preferably a three and one half inch form factor disc drive assembly. Other embodiments of the ISE 202 may be implemented in form factor assemblies smaller than three and one half inches. For example, it is envisioned that the ISE 202 may be palm sized and fit into a person's pocket for easy portability. Thus, the ISE 202 provides the advantages of mass data storage, easy portability, and executable software applications. The ISE 202 may be viewed as a network node on the network 212, having an operating system, a file system, and data storage disc media 204 for accessing files and communicating file data to the network 212 via the communication link 214. The file system manages files and is integrated with the operating system and the data storage disc access technology. The file system can be designed to take advantage of the method and system of accessing the data storage disc 204 to make file retrieval and storage more efficient and faster than prior art approaches.

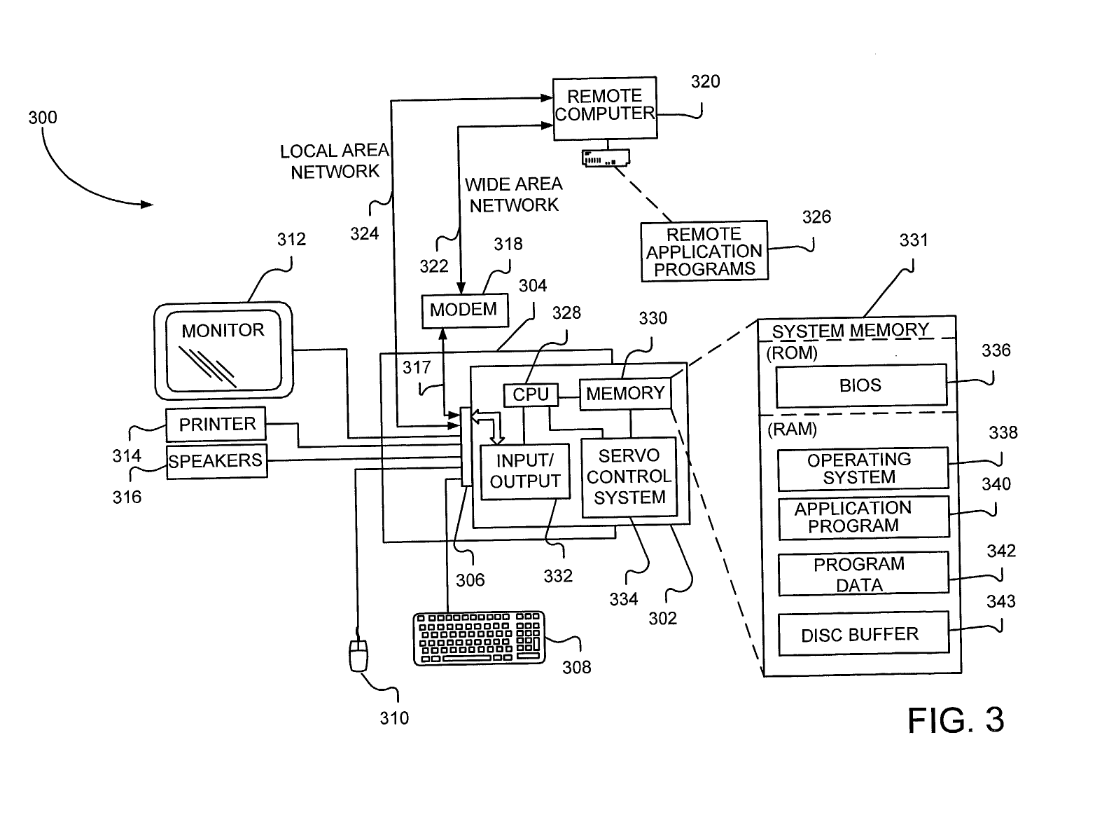

FIG. 3 illustrates an environment 300 in which an exemplary embodiment of the ISE 302 may be implemented. The exemplary intelligent storage element (ISE) 302 is connected to a docking station 304 providing connections to a number of system components. The docking station 304 preferably includes a connector port 306 mates with a connector (not shown) on the ISE 302. Examples of system components in operable communication with the ISE 302 via the connector port 306, are a keyboard 308, a mouse 310, a monitor 312, a printer 314, and speakers 316. A connection 317 to a modem 318 may also be provided by the docking station 304, so that the ISE 302 is in operable communication with a remote computer 320 via a wide area network 322. The connector port 306 may also provide a connection to a local area network 324 that provides communication to the remote computer 320. The remote computer 320 may have remote application programs 326 that the ISE 302 can access via one of the networks (322 or 324).

The ISE 302 includes a CPU 328, a memory 330, an input/output module 332, and a servo control system 334. The memory 330 includes a system memory 331 having, but not limited to, a basic input/output system (BIOS) 336, an operating system 338, an application program 340, program data 342, and a disc buffer 343. Application programs 340 may include generic productivity software, such as spreadsheets, word processors, and database programs, as well as custom and packaged programs for payroll, billing, inventory and other accounting purposes. The logical components of the ISE 302 may be implemented in hardware logic or software or a combination of software and hardware logic. System memory 331 may be allocated dynamically to the components in the ISE 302. For example, when an application program 340 requires less memory, free memory may be allocated to the I/O modules 332, or the disc buffer 343.

Those skilled in the art will recognize that the logical components illustrated may be integrated into one or more components in any combination. For example, the CPU 328, the memory 330, and the input/output module 332 may be implemented on a single silicon chip. The memory 330 may be, but is not limited to, random access memory (RAM), read only memory (ROM), electrically erasable programmable read only memory (EEPROM), flash memory, or a data disc (for example 108 of FIG. 1). A basic input/output system 336 (BIOS), containing the basic routines that help to transfer information between elements within the ISE 302, such as during start-up, is typically stored in ROM. RAM typically contains data and/or program modules that are immediately accessible to and/or presently being operated on by CPU 328.

By way of example, and not limitation, FIG. 3 illustrates data items such as an operating system 338, application programs 340, program data 342, and a disc buffer 343. These data items of the system memory 331 may each be physically located on different memory media, or in different partitions of the same memory media. For example, the operating system 338 and application data 340 may reside on the disc 108, while program data 342 may reside on an EEPROM in the ISE 302. At power up, the CPU 328 may load the operating system 338 into a synchronous dynamic random access memory (SDRAM) chip and execute the operating system 338 from the SDRAM. Similarly, an application program 340 may be loaded into and executed from a faster memory chip as applications are used. Advantageously, memory may be integrated in the ISE 302, which thereby allows for compression of the memory model and elimination of redundant components. It is further envisioned that the disc buffer 343 may be unnecessary in specific implementations of the ISE 302 because of component integration provided by the ISE 302. Thus, the CPU 328 may read and write directly from and to the data storage disc (such as 204).

The CPU 328 runs the operating system 338. The operating system 338 is operable to run an application program 340. The CPU operably communicates with the servo control system 334 to retrieve and store data on a data storage disc in the ISE 302. The CPU 328 is also in operable communication with the input/output module 332 to transmit data to and receive data from the external components. For example, the application program 340 may be a word processing program accepting user input via the keyboard 308. Input received from the keyboard 308 enters the input/output module 332 and is processed by the CPU 328. In response to keyboard input, data may be transmitted to the monitor 312 via the input/output module 332 whereby information may be displayed to a user on the monitor 312. When the user chooses to save data, the CPU 328 accesses the servo control system 334 to save the data on a data storage disc in memory 330. The servo control system 334 and corresponding data storage disc in memory 330 are functionally similar to servo system and the disc 108 illustrated in FIG. 1. It is envisioned that the ISE 302 is in a 3 ½ inch form factor case.

The process of saving the data to the hard disk can include any protocol that may be optimized for a particular application or type of ISE. The embodiment shown in FIG. 3 allows for tight coupling of the operating system, the file system, and the disc media. Consequently, the logical block address (LBA) abstraction is not required. The file system may be designed or modified to take advantage of the intimate knowledge of the hard disc assembly (HDA) implementation. The details of locating a logical block address can be embedded in the file system of the ISE and, thus, is transparent to a user of the ISE. For example, LBA 1 need not be physically adjacent to LBA 2. Consequently, the ISE can be made more efficient and faster in disc accesses.

An alternative embodiment of the system shown in FIG. 3 is a kiosk system wherein kiosks are available at various sites and the small, lightweight ISE 302 can be carried to the kiosk sites. For example, a kiosk may be on the back of an airplane seat to allow users of ISEs 302 to dock into the kiosk and do computing on the airplane. The kiosk may be functionally similar to the docking station 304 in that the kiosk may also provide video, sound, printing, networking, keyboard, and mouse functions.

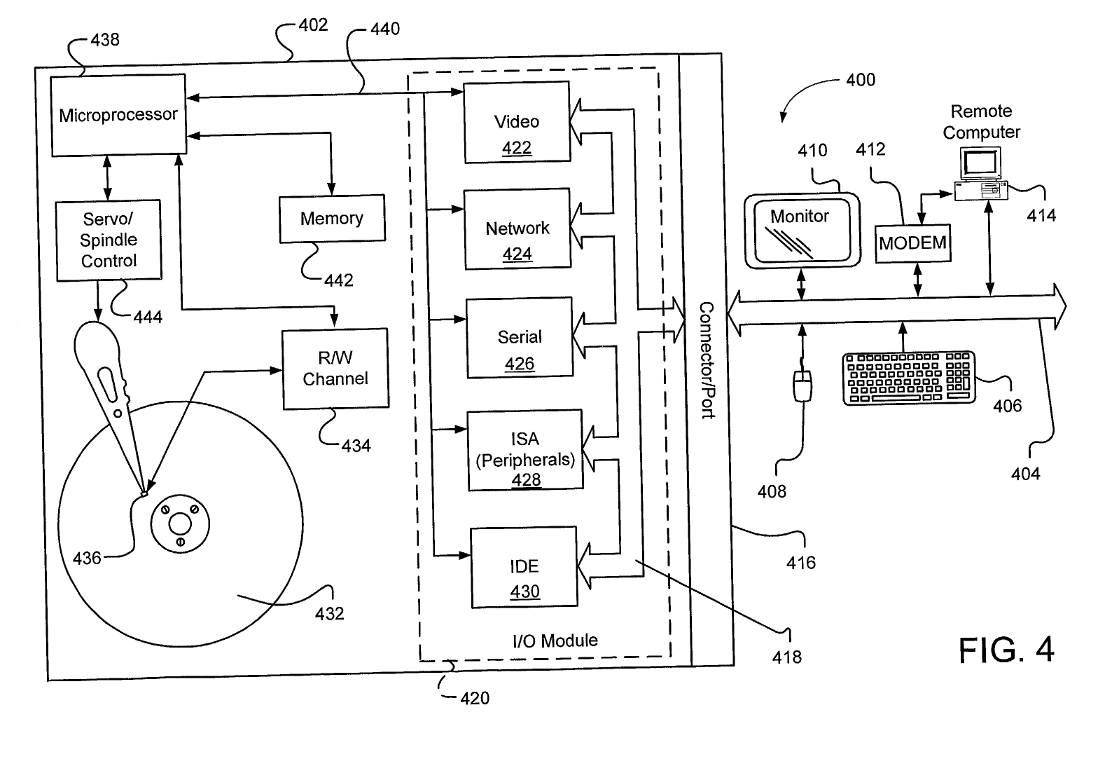

FIG. 4 illustrates a logical block diagram of an environment 400 employing an embodiment of an intelligent storage element 402. The intelligent storage element (ISE) 402 is connected to a communications bus 404 whereby the ISE 402 interfaces with a number of components communicating via the bus 404. Exemplary components on the bus 404 are a keyboard 406, a pointing device, such as a mouse 408, a monitor 410, a MODEM 412, and a remote computer 414. The ISE 402 includes a connector port 416 that is operably connected to the bus 404. The connector port 416 functions to communicate data from the bus 404 to a system bus 418 in the ISE 402.

The ISE 402 includes an input/output module 420, whereby data is communicated from the ISE 402 to the bus 404 vice versa. The input/output module 420 may include a number of modules, such as a video interface 422, a network interface 424, a serial interface 426, an industry standard architecture (ISA) interface 428, and an integrated drive electronics (IDE) interface 430. The ISE 402 also includes a mass storage medium such as a data storage disc 432. Each of the modules, 422, 424, 426, 428, and 430, typically includes an associated memory buffer, which facilitates high-speed data transfer between the bus 404 and the ISE 402. Data to be written to the data storage disc 432 are passed from the bus 404 to one of the interfaces 422, 424, 426, 428, and 430, and then to a read/write channel 434, which encodes and serializes the data.

The read/write channel 434 also provides the requisite write current signals to the heads 436. To retrieve data that has been previously stored by the ISE 402, read signals are generated by the heads 436 and provided to the read/write channel 434, which processes and outputs the retrieved data to the interfaces 422, 424, 426, 428, and 430 for subsequent transfer to the bus 404. As also shown in FIG. 4, a microprocessor 438 is operably connected to the interfaces 422, 424, 426, 428, and 430 via system communication line 440. The system communication line 440 typically comprises control lines, data lines, and interrupt lines. The microprocessor 438 can be any microprocessor known in the art, including, but not limited to, Motorola or Intel microprocessors. The microprocessor 438 provides top level communication and control for the ISE 402 in conjunction with programming for the microprocessor 438 which is typically stored in a microprocessor memory (MEM) 442. The MEM 442 can include random access memory (RAM), read only memory (ROM), and other sources of resident memory for the microprocessor 438. Additionally, the microprocessor 438 provides control signals for spindle and servo control 444.

The ISE 402 in the embodiment of FIG. 4 is preferably a three and one half inch form factor assembly. As discussed earlier, the ISE 402 may be implemented in smaller form factors for easy portability. Thus, the ISE 402 is preferably no larger than the size of a typical hard disc drive, and integrates the communications interface components that are typically resident in a computer. The video interface 422 preferably includes hardware and software components to drive the monitor 410 with a video signal. The network interface 424 includes hardware and software operable to transmit and receive network messages on and off the bus 404 so that the ISE 402 can communicate with the computer 414 on the bus 404. The network interface 424 typically can communicate with the MODEM 412 as one possible means of communicating to the computer 414. The remote computer 414 may be any computerized communication device known in the art. By way of example, and not of limitation, the remote computer 414 can be a desk top computer, a laptop computer, a server computer, or a hand held device, such as a personal digital assistant (PDA). The serial interface 426 preferably includes hardware and software operable to interact with the mouse 408 and the keyboard 406.

The ISA interface 428 preferably includes hardware and software operable to interact with peripheral devices that may be connected to the bus 404. Peripheral devices may include, but are not limited to, speakers, printers, scanners, and digital cameras. The IDE interface 430 preferably includes hardware and software operable to interface with an IDE bus. In one embodiment, the IDE interface 430 serves to interface between the other interface modules 422, 424, 426, and 428 and the microprocessor 438.

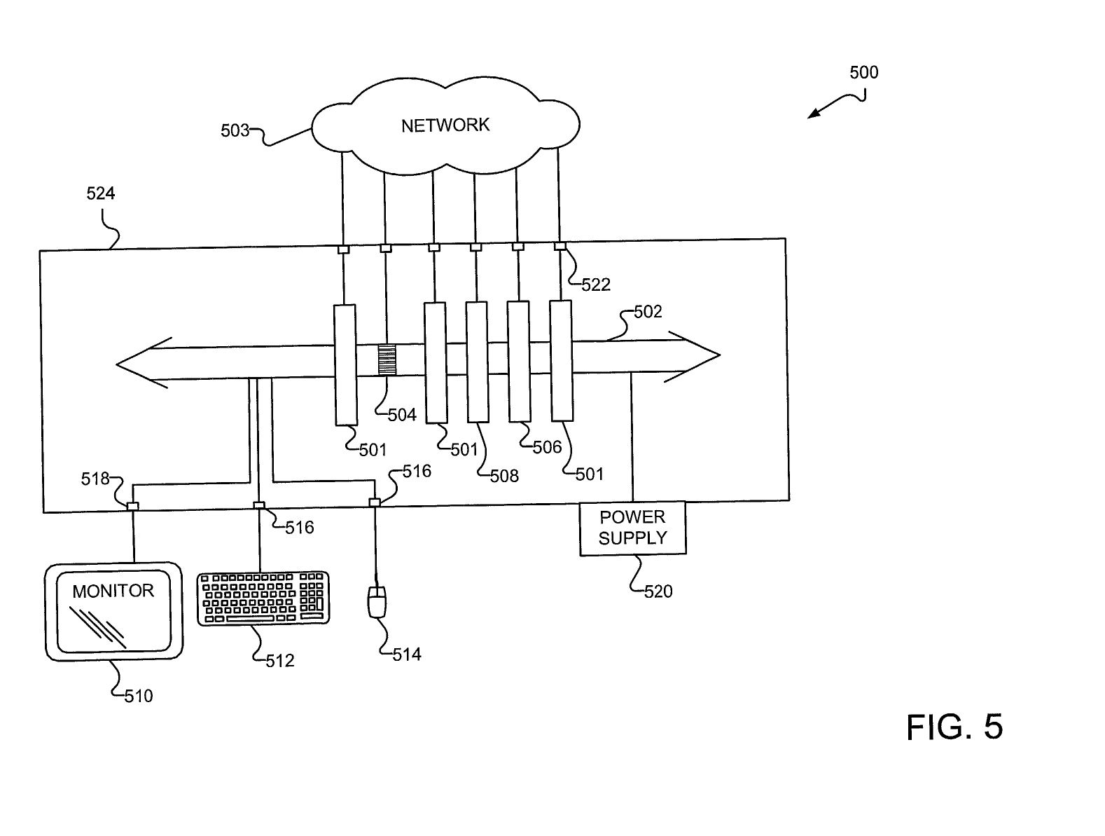

FIG. 5 is a suitable network environment 500 for implementing an embodiment of the present invention. The environment 500 in FIG. 5 is particularly suited for distributed processing applications. FIG. 5 illustrates a cluster 524 of intelligent storage elements 501 in operable communication with each other via a bus 502. When multiple intelligent storage elements are connected to a network or communications bus, processing may be distributed among the intelligent storage elements. This allows for parallel processing using multiple processors, and can improve computing performance.

Intelligent storage elements (ISEs) 501 are connected to a bus 502 providing communications among the ISEs 501. The bus 502 includes connection points 504 compatible with a connector on an ISE 501, whereby an ISE 501 can be connected to the bus 502. As mentioned earlier, each ISE 501 includes a central processing unit operable to run one or more application programs. In the distributed processing system of FIG. 5, a master ISE 506 performs master functions. A master ISE 506 is structurally no different than other ISEs 501. The only difference is in the functions the master ISE 506 performs. Master functions include, but are not limited to, distributing tasks among the ISEs 501, prioritizing tasks, receiving data from the bus, and transmitting the data to a corresponding ISE 501.

The communications bus 502 can be any structure supporting any protocol. Examples of bus structures are integrated drive electronics (IDE), small computer system interface (SCSI), peripheral component interconnect (PCI), and extended industry standard architecture (EISA). The bus 502 can also be a proprietary structure supporting a proprietary protocol. Bus protocols that may be utilized on the bus 502 include, but are not limited to, time division multiplexing (TDM), token-ring, packet based, or dedicated-wire schemes. The bus architecture may be synchronous or asynchronous. Those skilled in the art will recognize how the ISE 501 and the bus 502 can be adapted to achieve any of a variety of communications configurations.

Also shown in FIG. 5 is a communications network 503 operably communicating with one or more of the ISEs 501. By way of example, and not limitation, the communications network 503 can be a wired network, a direct-wired connection, or a wireless network. Examples of wired networks are Ethernet or telephone networks. Examples of wireless include acoustic, RF, infrared and other wireless media. Preferably, the communications network 503 and the ISEs 501 support a protocol such as hypertext transport protocol (HTTP), transmission control protocol/internet protocol (TCP/IP), file transfer protocol (FTP), or network file system (NFS). Each ISE 501 is connected to the network 503 via a network connector 522. Examples of network connectors 522 known in the art are RJ-11, RJ-45, or RJ-48. Each ISE 501 can maintain a separate connection to the network 503.

Preferably, each ISE 501 has an associated unique identifier, whereby bus data can be associated with a particular ISE 501. In one embodiment, the identifier is an internet protocol (IP) address. Nodes on the network 503 use the IP address of the master ISE 506 to communicate to the cluster 524. The master ISE 506 receives data from the network 503 and, in response, distributes the data to an associated ISE 501. The master ISE 506 typically attaches an identifier to any data sent to a particular ISE 508 so that only the particular ISE 508 listens to the data. Thus, to external nodes, the cluster 524 has a unique IP address, and individual ISEs 501 within the cluster 524 have subgroup addresses. The master ISE 506 performs a masking function by filtering information received from the network 502 and distributing information appropriately to the ISEs 501. The ISEs 501 respond to data received from the master ISE 506 by processing data and sending data on the bus to other ISEs 501. Depending on the protocol of the bus 502, data sent to and from the ISEs 501 will be transmitted over the bus 502 at various times. For example, the protocol may dictate time frames in which each ISE 501 is given a unit of time to transmit data. As another example, data from ISEs 501 may be sent in response to a command from the master ISE 506.

Processing may be distributed in any manner suitable to the particular application. For example, in a typical office computing system involving an email application, a word processing application, and an Internet browsing application, each ISE 501 in the cluster 524 may be assigned to one of the applications. One ISE may be given image-processing tasks to process images for use in other applications, such as email and word processing. Alternatively, a single application program may be executed by the entire cluster 524, wherein subtasks within the application program are distributed among the ISEs 501. The master ISE 506 can employ a rule-based system in determining how to distribute tasks. A rule-based system may take into account the processing power of particular ISEs in determining whether to distribute an image processing task to an ISE. Processes may be distributed dynamically or statically. For example, the master ISE 506 may employ rules to distribute a task each time a task is received on the bus 502.

The embodiment of FIG. 5 allows for failure recovery. Failure recovery involves substituting one ISE for another if one the ISEs fails. For example, if the master ISE 506 fails, a backup ISE 508 can become the master ISE 506. The backup ISE 508 preferably has data representing the priority and distribution of tasks to the ISEs 501. Thus, the ISE 506 and the ISE 508 may be redundant masters.

Also shown in FIG. 5 are components connected to the communications bus 502. Exemplary components are a monitor 510, a keyboard 512, and a mouse 514. The keyboard 512 and the mouse 514 are connected to the bus 502 with connectors 516. The connectors 516 can be PS-2 connectors commonly used in computer systems. The monitor 510 is connected to the bus 502 via a connector 518. The connector 518 can be a 15 pin D connector commonly used in most computer systems. The monitor 510, keyboard 512, and mouse 514 allow a user to interact with applications running on the ISEs 501. For example, a mouse pointer movement from the mouse 514 sends a signal carrying data representing the mouse movement to the master ISE 506 via the bus 502. The master ISE 506 determines that the signal carries data associated with the presentation on the monitor 510. The master ISE 506 can then send the signal to an ISE 501 that performs the task of updating the monitor presentation so that the mouse pointer can be rendered at a new position. A power supply 520 is connected to the bus to provide power to the ISEs 500. The power supply is preferably a small form factor external power adapter providing direct current (DC) power.

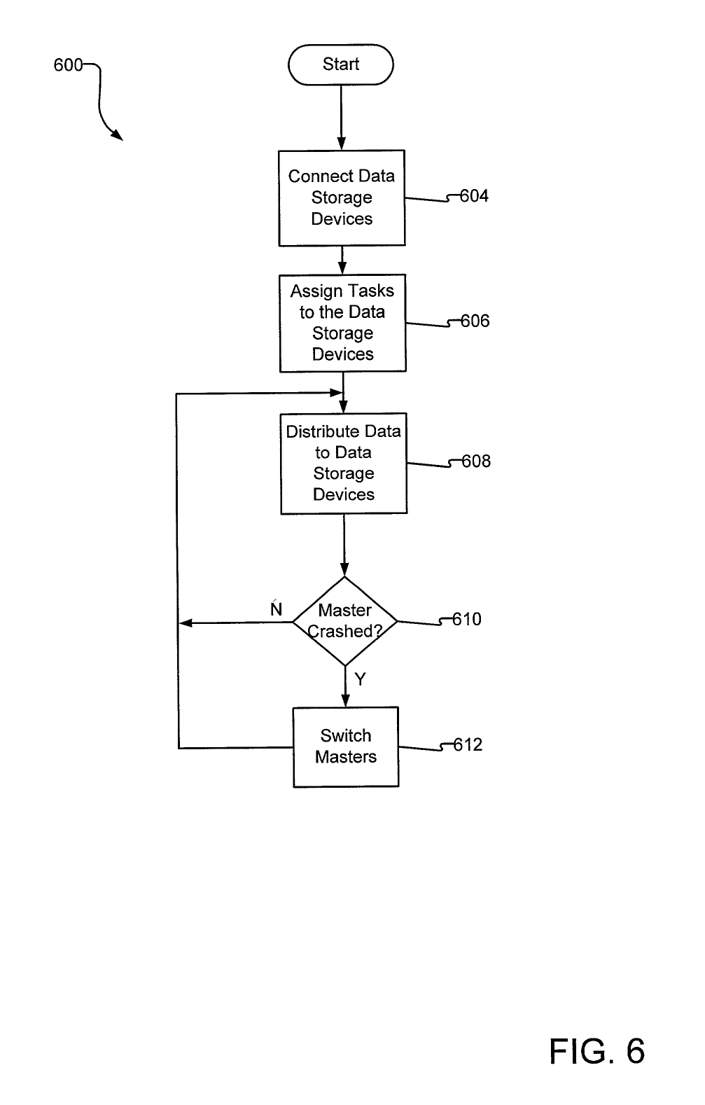

FIG. 6 is an operational flow 600 illustrating exemplary method steps involved in a distributed processing system such as the system shown in FIG. 5. ISEs, such as the ISE 501, are connected on a communication bus in a connecting operation 604. An assigning operation 606 assigns priorities and tasks among the ISEs 501. Preferably a primary master ISE, such as the primary master ISE 506 assigns the priorities and tasks among the ISEs 501 in the assigning operation 606. During the assigning operation 606, a secondary master ISE, such as the secondary master ISE 508, is assigned a task of monitoring the primary master ISE 506 for proper operation. Tasks that may be assigned in the assigning operation 606 may be any computer tasks, including, but not limited to, word processing, e-mail, computational, or billing tasks. In a distributing operation 608, the initial master ISE 506, or a secondary master ISE 508, receives data from the communication bus and distributes the data to an associated ISE 501. In a determining operation 610, it is determined whether the primary master 506 has crashed. Preferably, the determining operation 610 is performed by one of the other ISEs, such as the secondary master ISE 508. If the primary master ISE 506 has not crashed, the distributing operation 608 continues to distribute data. If, on the other hand, the master ISE 506 has crashed, a switching operation 612 switches from the primary master ISE 506 to the secondary master ISE 508. The secondary master ISE 508 then distributes the data in the distributing operation 608. Processing continues in this fashion until the cluster 524 is powered down.

In summary, an embodiment of the present invention may be viewed as a data storage device (such as 202) that has a data disc (such as 204) mounted on a baseplate (such as 102). The embodiment may include an actuator arm (such as 114) that carries a transducer (such as 118) for reading and writing data from and to the data disc (such as 204). An embodiment may further include a printed circuit board (PCB) fastened to the baseplate (such as 102) having a servo controller (such as 334) that can communicate with the actuator arm (such as 114) to move the actuator arm over the data disc (such as 204). Further, an embodiment may include a central processing unit (CPU) (such as 328) connected to the PCB generating control signals to the servo controller (such as 334) and running an operating system (such as 338). The operating system (such as 338) may be stored in a memory (such as 331). The memory may further store an application program (such as 340) that is connected to the CPU (such as 328) so that the application program (such as 340) may be run by the CPU (such as 328). The data storage device may be connected to a communications network (such as 324) and include an input/output module (such as 332) that can communicate to a node (such as 320) that is connected to the communications network (such as 324).

Another embodiment may be viewed as a computer system (such as 300) that includes a docking station (such as 304) that has a connector port (such 306) for receiving a data storage device (such as 302). The data storage device (such as 302) may have a microprocessor (such as 328), a memory (such as 331) storing an operating system (such as 338) that is connected to the microprocessor (such as 328). The operating system (such as 338) is preferably operable to execute application programs (such as 340). The microprocessor (such as 328) executes the operating system (such as 338). Further included may be an input/output module (such as 332) operably connected to a communications network (such as 324), and a data storage disc (such as 104). The data storage device (such as 302) is preferably connected to the network (such as 324). The computer system may further include a connection (such as 306) to a communications network (such as 324).

An embodiment may also be viewed as a method of distributing (such as 600) computer processing tasks by connecting (such as 604) intelligent storage elements (such as 501) to a communications bus (502), assigning (such as 606) tasks to each of the intelligent storage elements (such as 501), and distributing (such as 608) data among the intelligent storage elements (such as 501) based on the assigning (such as 606) of tasks. An embodiment may further include determining (such as 610) if a primary master intelligent storage element (such as 506) has crashed, and engaging (such as 612) a secondary master intelligent storage element (such as 508) if the primary master intelligent storage element (such as 506) has crashed.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, the intelligent storage element can include a peer-to-peer communications module providing communications among components connected to a network. Also, an intelligent storage element can have a security module to protect the privacy of the user. Numerous other changes may be made which will readily suggest themselves to those skilled in the art and which are encompassed in the spirit of the invention disclosed and as defined in the appended claims.

What is claimed is:

1. A data storage device in a form factor assembly not greater than three and one half inches comprising:
a data disc rotatably mounted on a baseplate;
an actuator arm adjacent to the data disc carrying a transducer for reading data from and writing data to the data disc;
a printed circuit board (PCB) fastened to the baseplate having a servo controller in operable communication with the actuator arm for moving the actuator arm over the data disc;
a central processing unit (CPU) connected to the PCB generating control signals to the servo controller and running an operating system; and
memory storing an application program operably connected to the CPU, whereby the application program is run by the CPU.

2. The data storage device of claim 1 wherein the data storage device is connected to a communications network, further comprising:
an input/output module communicating to a node connected to the communications network.

3. The data storage device of claim 2 wherein the input/output module includes a network interface module operable to communicate to a node on the network using a hypertext transport protocol.

4. The data storage device of claim 3 wherein the input/output module further includes a video interface module operable to drive a video monitor via the communications network.

5. The data storage device of claim 4 wherein the data storage device is a three and one half inch form factor assembly.

6. The data storage device of claim 5 further comprising a file system managing file data stored on the data disc, wherein the file system is in direct communication with the servo controller.

7. A computer system comprising:
a docking station having a connector port for receiving a data storage device; and
a data storage device having a microprocessor, a memory storing an operating system operably connected to the microprocessor operable to execute application programs, whereby the microprocessor executes the operating system, an input/output module operably connected to a communications network, and a data storage disc, the data storage device connected to the connector port.

8. The computer system of claim 7 wherein the docking station includes a connection to a communications network.

9. The computer system of claim 7 wherein the input/output module operably communicates with a node on the communications network using a hypertext transport protocol.

10. A method of distributing computer processing tasks comprising steps of:
connecting a plurality of intelligent storage elements to a communications bus, wherein each intelligent storage element comprises a microprocessor, a connector port, an input/output module, a data disc, and a servo controller for reading from and writing to the data disc;
assigning tasks to each of the plurality of intelligent storage elements; and
distributing data among the plurality of intelligent storage elements based on the assigning of tasks.

11. The method of claim 10 further comprising steps of:
determining if a primary master intelligent storage element has crashed; and
switching to a secondary master intelligent storage element if the primary master intelligent storage element has crashed.

12. The method of claim 11 wherein the assigning step comprises steps of:
selecting a first application program;
assigning the first application program to a first intelligent storage element;
selecting a second application program; and
assigning the second application program to a second intelligent storage element.

13. A data storage device in a form factor assembly not greater than three and one half inches comprising:
a microprocessor executing application programs;
a data disc;
an actuator assembly rotatably mounted adjacent the data disc for positioning transducer heads relative to the data disc;
a servo control module controlling the actuator assembly;
a memory containing the operating system and operably connected to the microprocessor, whereby the microprocessor runs the operating system; and
a communication means operably connected to the microprocessor and the memory for communicating data stored on the data storage device to a node on a communications bus.

14. The data storage device of claim 13 wherein the data storage device is connected to a communications network, further comprising:
an input/output module operable to receive data from a node on the communications network.

15. The data storage device of claim 14 wherein the input/output module operably communicates with a node on the communications network using a hypertext transport protocol.
